(19) United States
(12) Patent Application Publication
(10) Pub. No.: US 2012/0019065 A1
(43) Pub. Date: Jan. 26, 2012

(54) AUXILIARY POWER DISTRIBUTION AND CONTROL TO SPECIFIED CIRCUITS DURING POWER OUTAGES

(76) Inventor: Ronald A. Johnston, Longview, TX (US)

(21) Appl. No.: 13/190,462

(22) Filed: Jul. 25, 2011

Related U.S. Application Data
(60) Provisional application No. 61/367,060, filed on Jul. 23, 2010.

(51) Int. Cl. H02J 9/06

(52) U.S. Cl. 307/23

(57) ABSTRACT

A means is provided to connect a generator to an “auxiliary distribution box” that is permanently attached to the main distribution box in a home or building. The “auxiliary distribution box” contains circuit breakers, current and voltage sensing, a disconnect system utilizing relay contacts, and programmable controls to properly monitor and control the power distribution.

### FIELD OF THE INVENTION

This invention relates to the safe and simple distribution of electrical power, from a portable or auxiliary generator, to specific circuits in a home or building during a power outage. This invention includes a means of easily connecting the portable/emergency generator to an auxiliary distribution box that is installed adjacent or close to the home's main circuit breaker—distribution panel. Programming, timing, control and protection are also included in this invention.

### BACKGROUND

It is desirable, when living in an area that has frequent power outages, to have a means of portable emergency power. The distribution of this power can be confusing. First, safety is a concern, load distribution can be a problem, and “how and where to make a connection” can all be confusing to the homeowner. Also, the homeowner often drags multiple cords throughout the house to connect the desired appliances to the portable generator which can create a tripping hazard.

The main concerns when dealing with electricity is first of all safety. The primary issue deals with personal and personnel safety. The second issue is safety in preventing short circuits, overloads, property destruction, and possible fire hazards. Therefore, a safe but useable connection and distribution scheme has to be utilized.

The standard, typical setup in most American households and businesses is a dual single phase 220-240 vac system. Three wires, two hot and one neutral, enter the box from the utility company. The two “hot wires” measure 110-120 vac between each wire and neutral. The “neutral” becomes a reference. It is usually the white wire and is grounded to “earth ground” at or near the distribution box. Building codes now require an additional ground wire that is run to each receptacle, appliance, and light fixture. This provides another layer of protection and a means of utilizing ground fault protection, which will disconnect the circuit if a fault is detected. An auxiliary/emergency generator is compatible with these electrical requirements. This invention ties the generator to the existing distribution system.

### SUMMARY

A means is provided to connect a generator to an “auxiliary distribution box” that is permanently attached to the main distribution box in a home or building. The “auxiliary distribution box” contains circuit breakers, current and voltage sensing, a disconnect system utilizing relay contacts, and programmable controls to properly monitor and control the power distribution.

### BRIEF DESCRIPTION OF THE DRAWINGS

FIG. 1 shows a block diagram defining the main components this invention encircles. The Auxiliary Distribution Panel 102 represents the invention connecting a generator 101 to an existing distribution panel 103.

FIG. 2 shows a possible detail of an existing distribution panel. It details devices and typical distribution, which is well understood by those who work in the field. There are many scenarios of circuits and distribution schemes, so this figure in no way represents any one particular method.

FIG. 3 shows an arrangement of the described invention. The number of circuits and methods of control will depend on the needs, generator sizing, and load requirements of the items to be powered by the auxiliary generator.

FIG. 4 shows a simplified connection of the Auxiliary Distribution Box to the Existing Distribution Panel. Specific circuits are connected, indicating the primary items to be energized during the power outage.

FIG. 5 defines an embodiment that includes a means for an operator program input, a monitor to allow viewing of the program, programmable controls, and a set of relays and contacts for power distribution.

FIG. 6 shows a possible generator control panel. These of course vary by manufacturer, but all contain receptacles for specified types of outlets to connect with the desired electricity.

### DETAILED DESCRIPTION

Some of the obstacles of utilizing portable generator systems have to do with extension cords and plugging in the various appliances that need to be energized. Another problem is how much load the generator can tolerate, and how many appliances can be run at the same time? For example, can the refrigerator and freezer be run at the same time? Can the heater or air conditioner be run? If these questions are answered before power outages, then an appropriate plan can be made and appropriate connections implemented. Using simple switches allows the user to make the appropriate connections and decisions for connections without dragging cords and creating an unsafe scenario. To complete the design, current sensing, relay contacts, circuit breaker switches, connection methods to the existing distribution, and programmable control features are described.

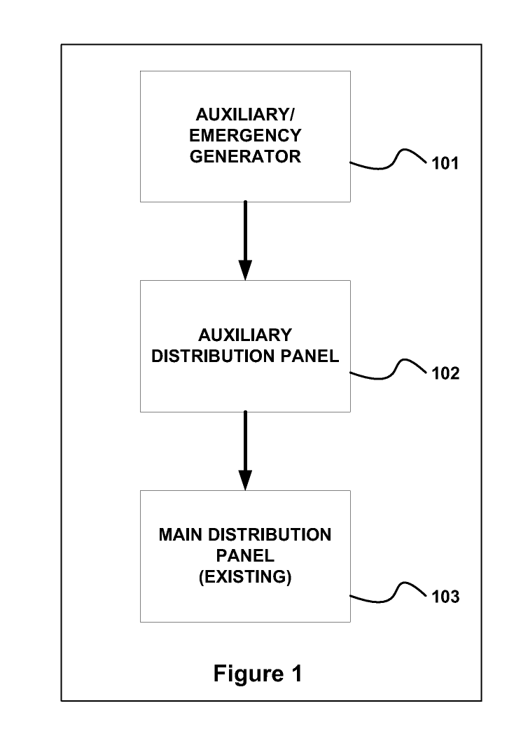

FIG. 1 shows a simplified block diagram defining the components this invention encompasses. The Auxiliary or Emergency Generator 101 provides required electrical power. The existing Main Distribution Panel 103 distributes the electrical power to various outlets, lights and appliances just as it normally does. The Auxiliary Distribution Panel 102 represents the invention, connecting the generator 101 to the existing distribution panel 103 in a selective manner to control load distribution and overloads.

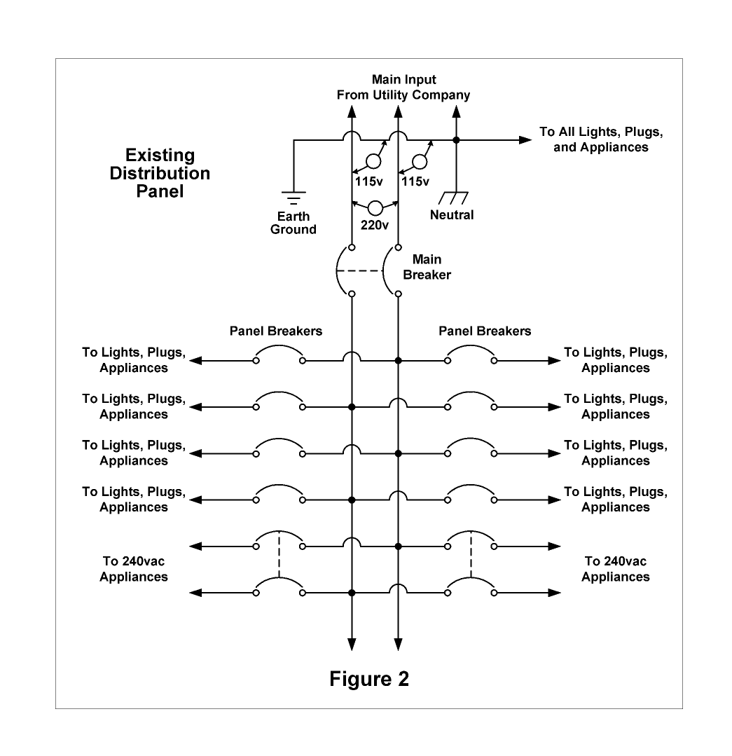

FIG. 2 shows a possible schematic detail of an existing distribution panel. It details devices and typical distribution, which is well understood by those who work in the field. In FIG. 2, the number of circuits, the size of the main breaker and individual circuit breakers will depend on the size and overall capacities of the particular home or building.

In the typical setup of most American households and businesses, the distribution panel is a dual single phase 220-240 vac system. Three wires enter the box from the utility company. Two wires are considered “hot” and measure 220-240 vac between them and the other is called “neutral”. The two “hot wires” also measure 110-120 vac between each wire and neutral. The “neutral” becomes a reference. It is usually the white wire and is grounded to “earth ground” at or near the distribution box. This is usually done by attaching it to a stake or pipe that is driven well into the earth. All 240 vac appliances operate from the two “hot” wires, and all 120 vac appliances operate from one “hot” wire to neutral. The 240 vac outputs typically go to stoves, ovens, hot water heaters, dryers, and air conditioning systems. The two 120 vac circuits are distributed to the remaining 120 vac lights, receptacles and appliances. There are many scenarios of circuits and distribution schemes, so this figure in no way represents any one particular method.

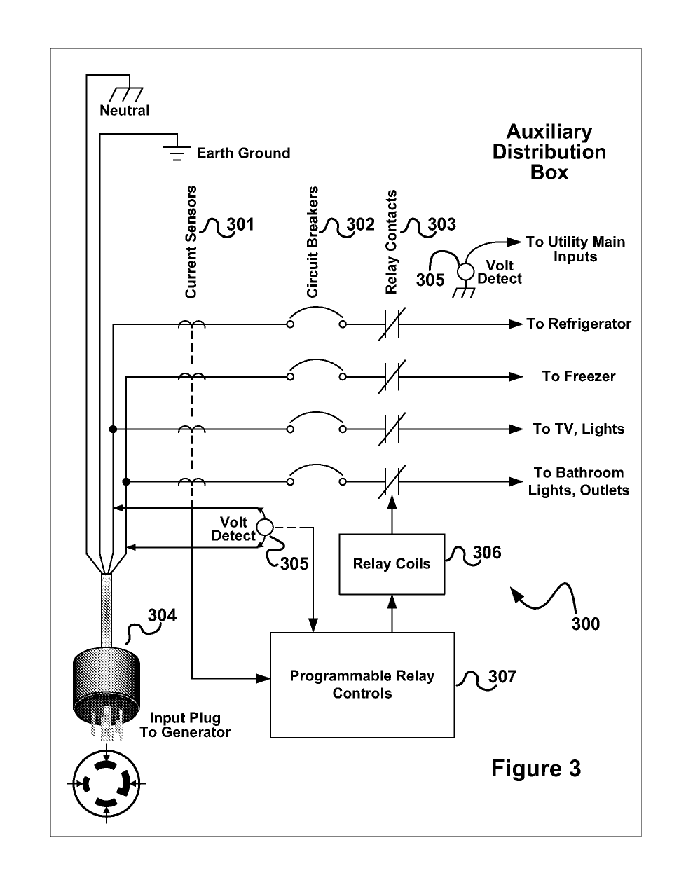

FIG. 3 shows a method 300 for connecting and controlling the load and distribution of an auxiliary generator to an existing home or building distribution system. It is a schematic representation of the Auxiliary Distribution Box invention. The number of circuits and methods of control will depend on the needs, generator sizing, and load requirements of the items to be powered by the auxiliary generator

The generator is connected to the Auxiliary Distribution Box 300 via a built in plug 304. Since the generator will have built-in receptacles for connections, this plug will need to match the main generator receptacle that is capable of the full generator output. A first glance evaluation would seem to indicate that a receptacle, similar to that on the generator, would be the best choice for this application. Then a cord could be used that had plugs that would match both the generator and the Auxiliary Distribution Box. However, safety indicates that this scenario would allow the blades of the plug to be electrically “hot” if one end were plugged into the generator, and the other not plugged into the box. This would be unacceptable so conditions must be in place to insure that the plug is never “hot” when the blades are exposed. The Auxiliary Distribution Box can be set up and interlocked to maintain an open circuit until it is plugged in to a proper location. The sequence may require that the generator be up and running and the plug inserted into the generator, before the control would allow the relay contacts in the Auxiliary Distribution box to be closed.

The programmable controls permit the safety issues to be addressed. Voltage sensors 305 are installed in the Auxiliary Distribution Box to keep the relay contacts 303 open if voltage is not sensed on the Input Plug 304. Also, if the existing Distribution box is feeding electricity to the Auxiliary box, the voltage sensor 305 will detect this and the relay contacts 303 will open.

The relay contacts 303 maintain the required control of the system so that if any improper condition occurs, the contacts will open, preventing the systems from conflict. This control comes from the sensors 301, 305 and system programming controls 307. These controls may energize and de-energize one or more, or the entire relay coils 306 as conditions dictate. This in turn opens and closes one or more, or the entire relay contacts 303.

If an over-current is detected by the Current Sensors 302 on one of the circuits, the relay contacts 303 are designed to open. If improper voltage is sensed, the relay contacts 303 are designed to open. If any kind of fault is sensed by any of the sensors, the appropriate contact or all of the relay contacts 303 are designed to open.

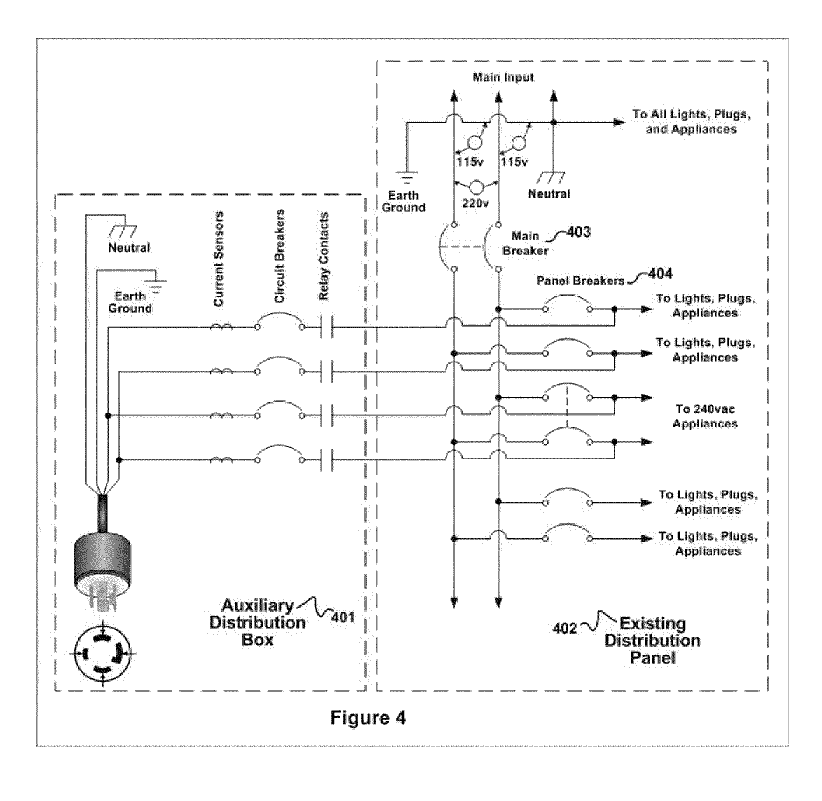

FIG. 4 demonstrates the connection of the Auxiliary Distribution Box 401 to the Existing Distribution Panel 402. In normal situations, when the power from the utility company is up and running, the Auxiliary Distribution Box 401 maintains all of the relay contacts open and the box is dormant. The figure shows that there are four auxiliary circuits, physically connected to four existing circuits in the house or building. These are selected by determining which appliances need to be operated during a power outage. FIG. 3 presented a scenario where one circuit went to the refrigerator, one to freezer, one to the TV and some lights, and one to the bathroom and some lights. The number of circuits, the capacity of the circuits, and the activity sequence are all pre-determined based on generator and appliance ratings. The number of circuits, contacts and sensors can be more or less than the example shown. The quantity and size will depend on the desired results and are not limited to the example shown.

The Auxiliary Distribution Box connects to the downstream side of individual circuits in the existing distribution box 402. The panel circuit breakers in the Existing Distribution Panel 402 that have these connections will be opened during the time auxiliary power is used. This prevents the auxiliary power from feeding back into the main circuit and energizing unneeded circuits. In all cases, any auxiliary power must not feed back to the utility input. This is a major safety hazard to utility workers. This means that the main breaker switch 403 must be open for any auxiliary or portable power generation.

The circuit breakers in the Auxiliary Distribution Box may be sized to match the capability of the generator. They will also have to not exceed the size of the existing circuit breakers they will temporarily replace. The connections shown in FIG. 4 may be to the circuits that need to be powered during the power outage. For example, one may go to the refrigerator, another to the TV or some lights, another to the deep freeze, and another to the air conditioner or heater or bathroom. In most cases the auxiliary generator will not be able to fully power everything in the household. Therefore decisions are made as to which circuits are necessary.

The relay contacts in the Auxiliary Distribution Box 401 may be used to cycle the loads. This allows the Auxiliary Box 401 to be configured to match the capabilities of the auxiliary generator. For instance, the generator may not have the capacity to run both the refrigerator and freezer at the same time. So the refrigerator is first run for a period time. Then it is disconnected and the freezer is run for a period of time. This may be accomplished through the programming of the relay circuits to open and close the individual relay contacts. The relay contacts and the current sensing give a greater measure of control to the system. The current sensing detects the amount of current used, and whether it is in the range of the generator capabilities. The relay controls can be programmed to fit the capacity of the auxiliary generator used.

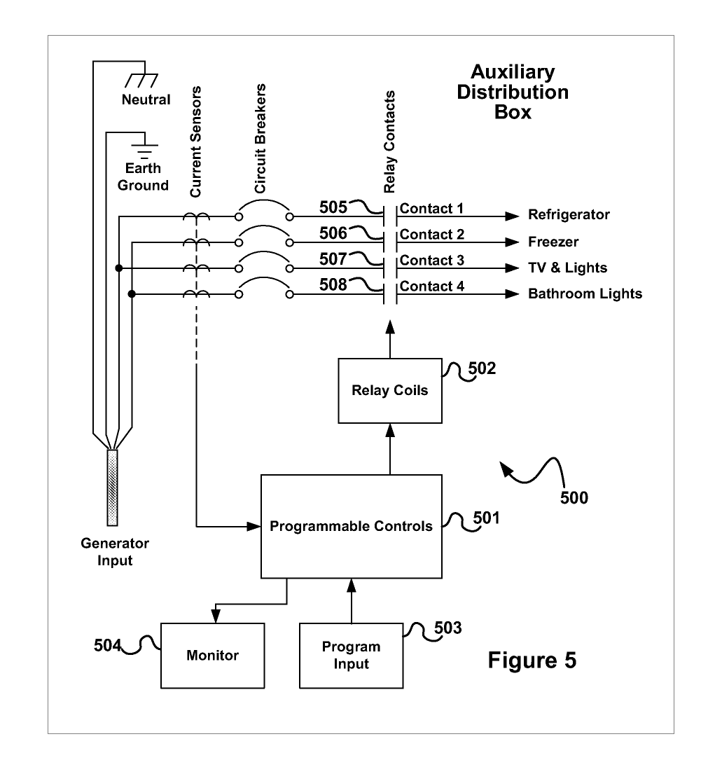

FIG. 5 describes an embodiment that includes a means for an operator to program the controls. The Program Input 503 may be a keyboard, a set of switches, a touch-pad, or some other means of inputting information. A monitor 504 allows viewing the program input to visually verify the program. This monitor may be a LCD or LED screen, a set of lights, or one of many monitor types readily available. The programmable controls 501 feature may incorporate a microprocessor or a computer chip to allow programming the desired features. It may contain the flexibility to allow a variety of scenarios and still protect against over currents. The Relay Contacts 505, 506, 507, 508 open close via the Relay Coils 502. The coils will energize and de-energize as demanded by the Programmable Controls 501.

In one possible embodiment, the system is utilizing a 3 KW generator. The maximum current output would be about 25 amps. The generator has the capability of running either the refrigerator or the freezer, both of which use about 15 amps, but not both at the same time. It can also run a few lights or the TV along with the refrigerator or freezer. In FIG. 5, this embodiment may set the program to close relay contact 1 505 going to the refrigerator, and open relay contact 2 506 going to the freezer for one hour. Then relay contact 1 505 would open and relay contact 2 506 may close for the next hour. The contacts 3 and 4 507, 508 to the TV and lights may stay closed. If the Current Sensors detect more than a total of 25 amps from all four circuits, then either Contact 3 or 4 will open to relieve the load. The order of sequence of opening a load is also programmable. The alternating of the refrigerator and freezer will keep things cold in both appliances without having the possibility of both items being on at the same time. If a 5 KW generator were used, then approximately 42 amps of current would be available. This scenario would allow both the refrigerator and freezer run at the same time, along with other lights, TV, and light appliances. Other factors also have to be considered. These may be the fuel usage of the generator, where a lighter load means a longer time before fuel needs to be replenished. Therefore the controls are programmed to insure the generator runs at a lighter load.

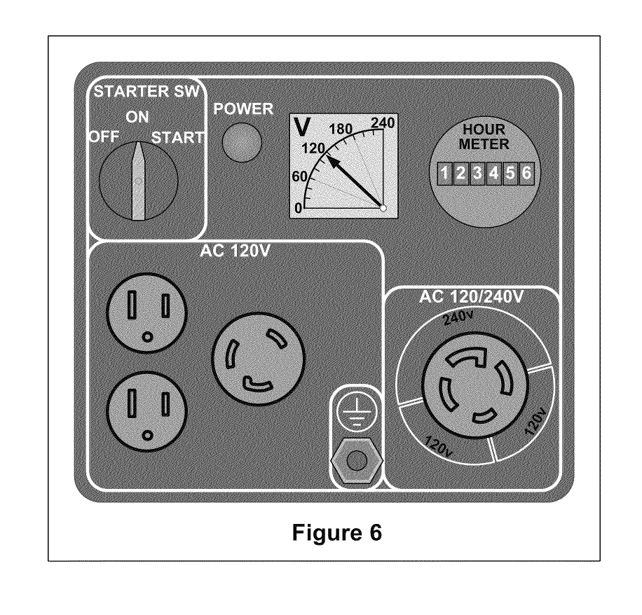

The power input plug from the generator to the Auxiliary Distribution Box is another variable factor. Most generators have built in plugs where inputs can be made. FIG. 6 shows a typical faceplate of a home auxiliary generator. These of course will vary with different brands and features. They will all contain some type of receptacles that are plugged in to provide the power to the desired appliance or lights. Another factor is voltage. The smaller auxiliary generators may only produce 120 vac. These would require a connection to the existing distribution box that only allowed the 120 vac items to run. No 240 vac appliances could be used. If the auxiliary generator has 240 vac capability and adequate capacity, then connections can be made that so 240 vac appliances could be run, i.e. air conditioner, stove, etc.

What is claimed is:

1. A system that connects to an existing home or building distribution box that will allow an auxiliary generator to power all circuits when the utility power grid is down.

2. The method of claim 1 wherein the auxiliary generator is connected to power specific circuits when the utility power grid is down.

3. The method of claim 1 wherein controls are implemented to govern connections of the auxiliary generator to power specific circuits when the utility power grid is down.

4. The method of claim 1 wherein controls are implemented to govern connections of the auxiliary generator to specific circuits and when and how long they remain activated when the utility power grid is down.

5. The method of claim 1 wherein controls are implemented to govern connections of the auxiliary generator to specific circuits and activate and de-activate these circuits based on loading and fault conditions.

6. A programmable system that controls the energizing and de-energizing of relay contacts for the purpose of directing auxiliary power to an existing home or building distribution panel when the utility power grid is down.

7. The method of claim 6 wherein the controls consist of a programmable computer chip or microprocessor.

8. The method of claim 6 wherein current and voltage sensors may determine a portion of the program control.

9. The method of claim 6 wherein timing and sequencing the relay contacts are part of the program control.
